(19) United States
(12) Patent Application Publication
(10) Pub. No.: US 2009/0114868 A1
(43) Pub. Date: May 7, 2009

(54) THROTTLE VALVE SET EQUIPPED WITH FIRST VALVE PLATE AND SECOND VALVE PLATE

(76) Inventor: Dong Soo Lee, Hwaseong-city (KR)

Correspondence Address: DONG SOO LEE, 10I-704, Poranjae Apt., Musong-dong, Hwaseong-city, Gyeonggi-do, KR

(21) Appl. No.: 11/955,660

(22) Filed: Dec. 13, 2007

(30) Foreign Application Priority Data
Nov. 7, 2007 (KR) 10-2007-0113220

(51) Int. Cl. F16K 1/18

(52) U.S. Cl. 251/305

(57) ABSTRACT

A throttle valve set for controlling an amount of intake air includes a shaft, a first valve plate connected to a first side of the shaft and rotating along with the shaft, a supporting plate connected to a second side of the shaft and rotating along with the shaft and the first valve plate, and a second valve plate at the second side of the shaft and rotatable with respect to the shaft. The supporting plate pushes the second valve plate such that the second valve plate rotates along with the shaft, the first valve plate, and the supporting plate if the supporting plate has rotated more than a certain amount. The valve plates may be semicircular, and the shaft may be disposed along the diameter of the circle. The second valve plate may have a depression configured for the supporting plate to be inserted therein.

### CROSS-REFERENCE TO RELATED APPLICATION

This application claims priority to, and the benefit of, Korean Patent Application No. 10-2007-0113220, filed in the Korean Intellectual Property Office on Nov. 7, 2007, the entire contents of which are incorporated herein by reference.

### BACKGROUND OF THE INVENTION

(a) Field of the Invention

The present invention relates to a throttle valve set with two valve plates.

(b) Description of the Related Art

A typical throttle valve is opened by depression of an accelerator pedal by a driver. In an idle state or an ignition state, an idle speed control actuator (ISCA) controls the throttle valve. The valve includes a circular plate that pivots about an axis along its diameter.

The amount of air passing by the throttle valve needs to be controlled accurately to control the amount of fuel supplied to the engine. However, the open portion increases in area rapidly, so precise control is difficult. Accordingly, it is difficult to achieve a precise air/fuel ratio.

The above information disclosed in this Background section is only for enhancement of understanding of the background of the invention and therefore it may contain information that does not form the prior art that is already known in this country to a person of ordinary skill in the art.

### SUMMARY OF THE INVENTION

A throttle valve set for controlling an amount of intake air includes a shaft, a first valve plate connected to a first side of the shaft and rotating along with the shaft, a supporting plate connected to a second side of the shaft and rotating along with the shaft and the first valve plate, and a second valve plate at the second side of the shaft and rotatable with respect to the shaft. The supporting plate pushes the second valve plate such that the second valve plate rotates along with the shaft, the first valve plate, and the supporting plate in the supporting plate has rotated more than a certain amount.

The valve plates may be semicircular, and the shaft may be disposed along the diameter of the circle.

The second valve plate may have a depression configured for the supporting plate to be inserted therein.

### BRIEF DESCRIPTION OF THE DRAWINGS

FIG. 1 is a perspective, partially schematic view of a throttle valve set according to an exemplary embodiment of the present invention.

FIG. 2 is an exploded perspective view of the throttle valve set of FIG. 1.

FIG. 3 is a cross-sectional view of the throttle valve set of FIG. 1.

FIG. 4 illustrates the operation of the throttle valve set of FIG. 1.

### DESCRIPTION OF REFERENCE NUMERALS INDICATING PRIMARY ELEMENTS IN THE DRAWINGS

102: rotation shaft
104: first valve plate
106: supporting plate
108: second valve plate
110: hollow shaft
112: driving portion
114: throttle position sensor
116: open spring
118: close spring
202: first opening
204: second opening
206: groove
302: supporting portion
304: spring

### DETAILED DESCRIPTION OF PREFERRED EMBODIMENTS

The present invention will be described more fully hereinafter with reference to the accompanying drawings, in which exemplary embodiments of the invention are shown.

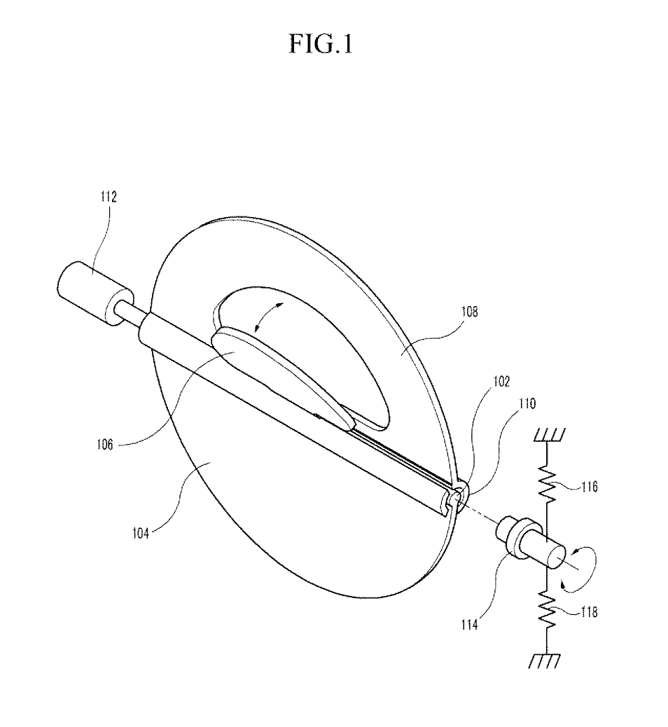

Referring to FIG. 1, a throttle valve set includes a rotation shaft 102, a first valve plate 104, a supporting plate 106, a second valve plate 108, a hollow shaft 110, a driving portion 112 and a throttle position sensor (TPS) 114.

The first valve plate 104 may have a shape defined by a circular arc and cord, such as the semicircle shown. The cord is disposed along the rotation shaft 102.

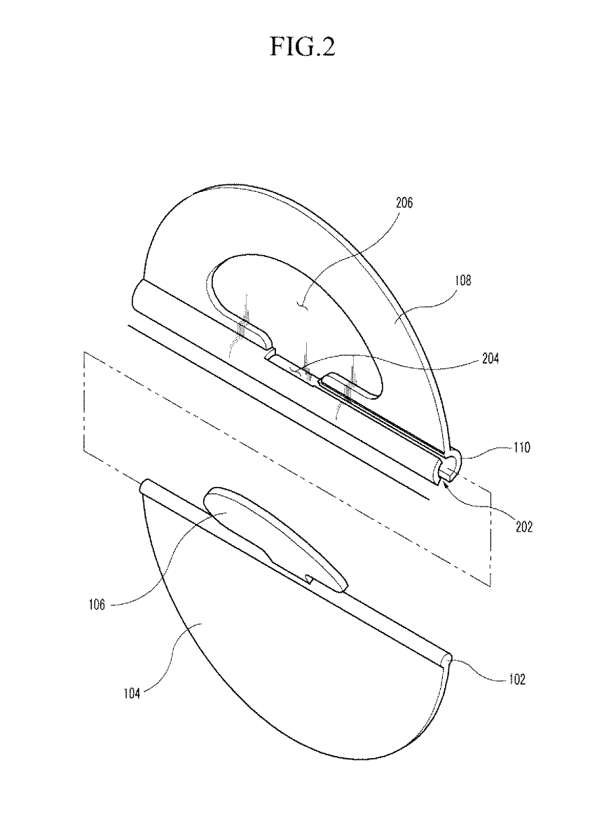

The hollow shaft 110 is substantially cylindrical, and the rotation shalt 102 is disposed therein. An open portion 202 (FIG. 2) is provided longitudinally in the hollow shalt 110, and the first valve plate 104 protrudes through the open portion.

The second valve plate 108 may have a shape defined by a circular arc and cord, such as the semicircle shown. The cord is disposed along the hollow shaft 110.

The rotation shaft 102 is connected to an actuator 112, which rotates the rotation shaft 102 depending on accelerator pedal manipulation by a driver. The rotational position of the rotation shaft 102 is detected by the throttle position sensor (TPS) 114. The rotation shaft 102 is biased toward its original position by an open spring 116 and a close spring 118.

Referring to FIG. 2, the second valve plate 108 is fixed to the hollow shaft 110. A first opening 202 and a second opening 204 are provided in the hollow shaft 110. The first opening 202 is longitudinal, and the second opening 204 is disposed in the middle of the hollow shaft 204.

The rotation shaft 102 is disposed in the hollow shalt 110, the first valve plate 104 protrudes through the first opening 202, and the supporting plate 106 protrudes through the second opening 204.

A depression 206 is provided on the second valve plate 108, and the shape of the depression 206 corresponds to that of the supporting plate 106.

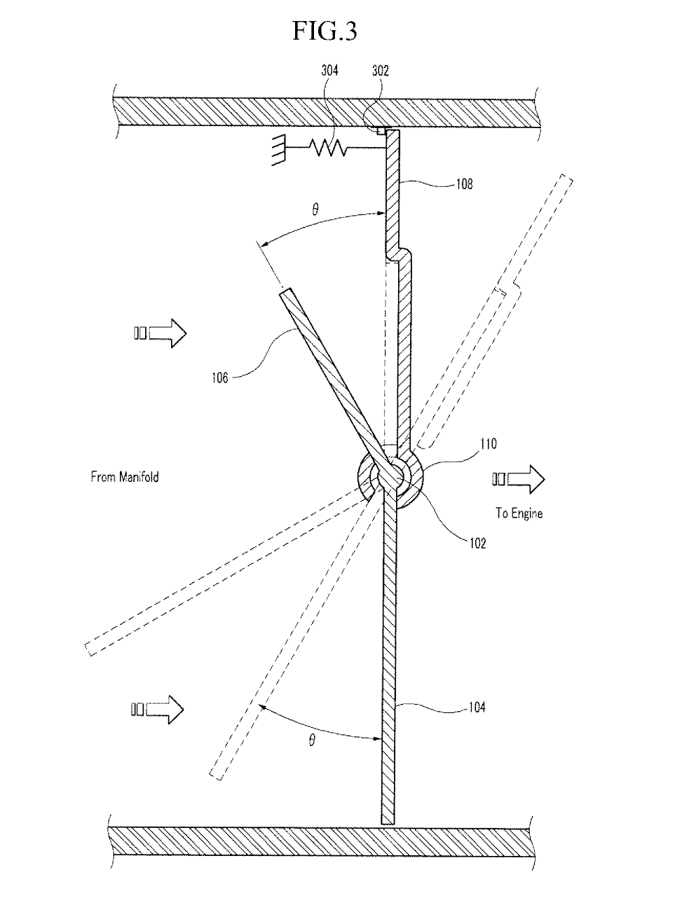

Referring to FIG. 3, the second valve plate 108 is supported elastically by a spring 304, and maintains its original position by a supporting member 302. Accordingly, the second valve plate 108 returns to its original position by the spring 304 and the supporting member 302.

The supporting plate 106 defines a fixed angle (180-Θ)° with the first valve plate 104. Θ may be, for example, 30°. For the first 30° that the first valve plate 104 rotates to the left in FIG, 3, the supporting plate 106 rotates integrally with it, but the second valve plate 108 is unaffected. Accordingly, the amount of air supplied to the engine is precisely controlled.

When the first valve plate 104 and the supporting plate 106 rotate more than Θ° by further depressing the accelerator, the supporting plate 106 presses against and rotates the second valve plate 108. Thus, both the first valve plate 104 and the second valve plate 108 rotate together.

When the throttle valve is closed completely, the plates have the configuration shown in solid lines in FIG. 3. 150° is defined between the first valve plate 104 and the supporting plate 106, and 30° is defined between the supporting plate 106 and the second valve plate 108.

The first valve plate 104 rotates in the 0° to 30° range in an idle state (when the engine operates but the accelerator is not pressed). This is referred to as the “idling angle.” Θ can be selected by a person of ordinary skill in the art based on the teachings herein, and based on the kind of engine. Preferably, 2°<≈Θ<≈40°.

Further, the second valve plate 108 can be rotated by the supporting plate 106 even in the idle state for some applications, such as if the coolant temperature is lower than normal in an idle state.

Also, for some applications, the second valve plate 108 does not rotate even though the accelerator pedal is pressed. For example, a limp-home angle is an angle in which the first valve plate 104 can rotate when the electronic throttle controller (ETC) is malfunctioning or has a disconnection short circuit.

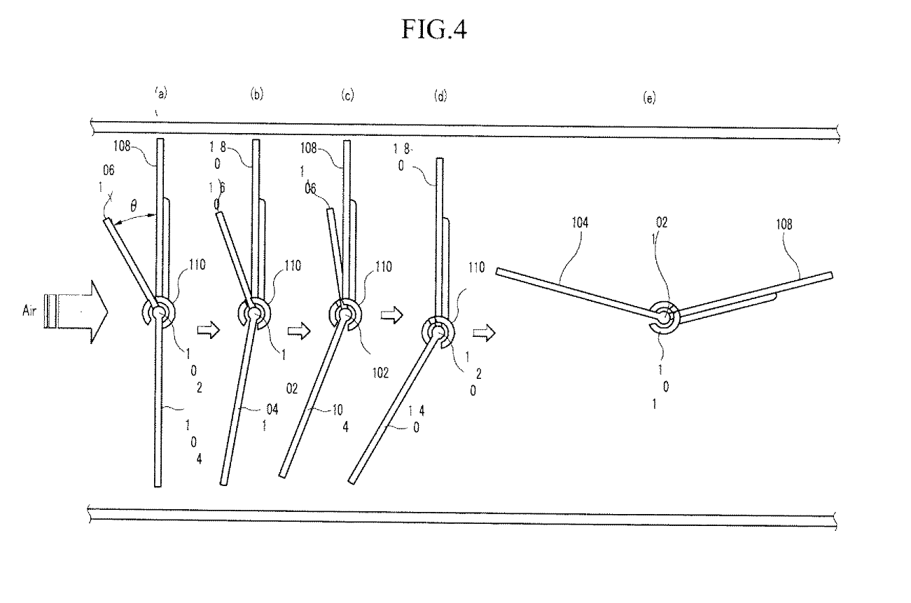

(a) in FIG. 4 shows a state in which the throttle valve is closed completely when the engine does not operate, (b), (c), and (d) in FIG. 4 show states in which the throttle valve is partially opened by the first valve plate 104 when the engine is in an idle state, and (e) in FIG. 4 shows a state in which the throttle valve is completely opened by the first valve plate 104 and the second valve plate 108 when the engine is operated fully.

The angle defined between the supporting plate 106 and the second valve plate 108 is 30° in FIG. 4(a), less than 30° in FIGS. 4(b) and (c), and 0° in FIGS. 4(d) and (e).

While this invention has been described in connection with what is presently considered to he practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A throttle valve set for controlling an amount of intake air, comprising:
a shaft;
a first valve plate that is connected to the shaft at a first side of the shaft and rotates along with the shaft;
a supporting plate that is connected to the shaft at a second side of the shaft and rotates along with the shaft and the first valve plate; and
a second valve plate at the second side of the shaft and rotatable with respect to the shaft;
wherein the supporting plate pushes the second valve plate such that the second valve plate rotates along with the shaft, the first valve plate, and the supporting plate if the supporting plate has rotated more than a certain amount.

2. The throttle valve set of claim 1, wherein the first valve plate comprises a shape substantially defined by a first arc and a cord of a circle, wherein the shaft is disposed along the cord.

3. The throttle valve set of claim 2, wherein the second valve plate comprises a shape substantially defined by a second arc and the cord of the circle.

4. The throttle valve set of claim 3, wherein the first and second arts are substantially semicircular and the cord is disposed substantially along a diameter of the circle.

5. The throttle valve set of claim 1, wherein the second valve plate comprises a depression configured for the supporting plate to be inserted therein.
